(19) United States
(12) Patent Application Publication
(10) Pub. No.: US 2015/0092455 A1
(43) Pub. Date: Apr. 2, 2015

(54) INTEGRATED MAGNETIC CIRCUIT AND METHOD OF REDUCING MAGNETIC DENSITY BY SHIFTING PHASE

(71) Applicants: Gyeongsang National University Office of Academy and Industry Collaboration, Gyeongsangnam-do (KR); SAMSUNG ELECTRO-MECHANICS CO., LTD., Gyeonggi-do (KR)

(72) Inventors: Jae Sun Won, Gyeonggi-do (KR); Jong Hae Kim, Gyeonggi-do (KR); Hwi Beom Shin, Gyeonggi-do (KR); Young Min Lee, Gyeonggi-do (KR); Se Kyo Chung, Gyeongsangnam-do (KR); Sang Dae Kim, Gyeonggi-do (KR)

(73) Assignees: Gyeongsang National University Office of Academy and Industry Collaboration, Gyeongsangnam-do (KR); SAMSUNG ELECTRO-MECHANICS CO., LTD., Gyeonggi-do (KR)

(21) Appl. No.: 14/023,251

(22) Filed: Sep. 10, 2013

(30) Foreign Application Priority Data
Sep. 10, 2012 (KR) 10-2012-0099877

(51) Int. Cl. H02M 1/42; H02M 3/335

(52) U.S. Cl. CPC H02M 1/4208; H02M 3/33507
USPC 363/21.12

(57) ABSTRACT

Disclosed herein are an AC-DC converter in which an inductor of boost PFC and a flyback transformer are integrated in one and a method of preventing a magnetic density from being saturated by shifting a phase. The integrated magnetic circuit according to an exemplary embodiment of the present invention includes: a power factor correction stage (PFC-stage) including a boost inductor; and a flyback transformer including a primary winding and a secondary winding, wherein the boost inductor and the primary winding of the flyback transformer and the secondary winding of the flyback transformer are wound around a single core.

### CROSS REFERENCE TO RELATED APPLICATIONS

This application claims the benefit under 35 U.S.C. Section 119 of Korean Patent Application Serial No. 10-2012-0099877 entitled “Integrated Magnetic Circuit And Method of Reducing Magnetic Density By Shifting Phase” filed on Sep. 10, 2012, which is hereby incorporated by reference in its entirety into this application.

### BACKGROUND OF THE INVENTION

1. Technical Field

The present invention relates to an integrated magnetic circuit and method of reducing magnetic density by shifting a phase.

2. Description of the Related Art

As power consumption of mobile electronic devices in addition to a notebook computer is increased, power required for an AC adapter supplying power to these electronic devices is increased. The AC adapter needs to be miniaturized so as to be easily carried. As a result, increasing power density of the AC adapter is a main design point. Currently, components occupying the largest volume among components of the AC adapter are magnetic components and a capacitor, in addition to a transformer. Therefore, for miniaturization of the AC adapter, the miniaturization and integration of the components are essential.

A power conversion circuit topology currently used in the AC adapter is sorted based on input power 75 W. In small capacity of 75 W or less, a single-stage scheme based on a flyback circuit is used and in 75 W or more, a two-stage scheme having a power factor correction (PFC) stage and a DC/DC converter stage has been used.

FIG. 1 is a circuit diagram of an AC-DC converter according to the related art.

Referring to FIG. 1, an AC-DC converter 10 may be divided into a PFC stage correcting a power factor and a DC-DC converter stage.

The PFC-stage includes a boost inductor 1 and a first switch Sa connected with the boost inductor 1 to supply a switching signal to the boost inductor 1 and the DC-DC converter stage includes a flyback transformer 2 and a second switch Sb connected with the flyback transformer 2 to supply the switching signal to the flyback transformer 2. The AC/DC converter to which an input power of 75 W or more is applied requires a power factor circuit and uses a two-stage scheme so as to satisfy power factor and output voltage characteristics. However, the two-stage scheme increases volume due to a PFC inductor and a DC/DC transformer and thus, increases costs. Therefore, there is a need to integrate the EEC inductor and the DC/DC transformer in a single core.

However, a general power supply apparatus according to the related art that is disclosed in Patent Document 1 uses a separate transformer for implementing the PFC and the DC/DC converter or the DC/AC inverter, and the like and as a result, has a limitation in miniaturization.

### RELATED ART DOCUMENT

### Patent Document

(Patent Document 1) Korean Patent Laid-Open Publication No. 2006-0079872

### SUMMARY OF THE INVENTION

An object of the present invention is to reduce a volume by a circuit design that winds a boost inductor and a winding of a flyback transformer of a power factor correction stage around a single core and save manufacturing costs due to a separate winding thereof.

Another object of the present invention is to prevent a magnetic flux from being saturated by setting a phase shift between a first switching signal supplied to a boost inductor and a second switching signal supplied to a flyback transformer to be 180°.

According to an exemplary embodiment of the present invention, there is provided an integrated magnetic circuit, including: a power factor correction stage (PFC-stage) including a boost inductor; and a flyback transformer including a primary winding and a secondary winding, wherein the boost inductor and the primary winding of the flyback transformer and the secondary winding of the flyback transformer are wound around a single core.

The core may be an EE core or an EI core, the boost inductor may be wound around a central leg of the core, the primary winding of the flyback transformer may be wound around an upper leg of the core, and the secondary winding of the flyback transformer may be wound around a lower leg of the core.

The integrated magnetic circuit may further include: a first switch connected with the boost inductor and generating a first switching signal having a first frequency; and a second switch connected with the flyback transformer and generating a second switching signal having a second frequency.

The first frequency and the second frequency may be the same.

The first frequency and the second frequency may have a phase shift of 180°.

The core may be an EE core or an EI core.

According to another exemplary embodiment of the present invention, there is provided a method of reducing a magnetic density by a phase shift, including: preparing a core including three legs; winding a boost inductor around a central leg of a core; forming a primary winding and a secondary winding of a flyback transformer around an upper leg and a lower leg of the core, respectively; and inputting a first switching signal according to a first frequency to the boost inductor and a second switching signal according to a second frequency having a phase shift of 180° with respect to the first frequency to the primary winding and the secondary winding of the flyback transformer.

The core may be an EE core or an EI core.

The first frequency and the second frequency may be the same.

### BRIEF DESCRIPTION OF THE DRAWINGS

FIG. 1 is a circuit diagram of an AC-DC converter according to the related art.

FIG. 2 is a diagram illustrating a core wound according to an exemplary embodiment of the present invention.

FIG. 3 is a flow diagram of a magnetic flux of the core according to the exemplary embodiment of the present invention.

FIG. 4 is a graph illustrating a case in which a first switching signal and a second switching signal for the core according to the exemplary embodiment of the present invention are in-phase and a case in which the first switching signal and the second switching signal have a phase shift of 180°.

### DESCRIPTION OF THE PREFERRED EMBODIMENTS

Hereinafter, exemplary embodiments of the present invention will be described in detail with reference to the accompanying drawings. However, this is only by way of example and therefore, the present invention is not limited thereto.

When technical configurations known in the related art are considered to make the contents obscure in the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, exemplary embodiments of the present invention will be described with reference to the accompanying drawings.

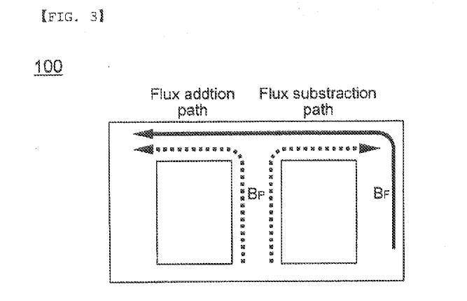

FIG. 2 is a diagram illustrating a core wound according to an exemplary embodiment of the present invention.

Referring to FIG. 2, an integrated magnetic circuit according to an exemplary embodiment of the present invention may include a power factor correction (PFC) stage including a boost inductor and a flyback transformer including a primary winding 51 and a secondary winding 61, wherein the boost inductor and the primary winding 51 of the flyback transformer and the secondary winding 61 of the flyback transformer may be wound around a single core.

The core may be an EE core or an EI core. In this case, the core may include three legs. Therefore, a coil 71 forming the boost inductor may be wound on a central leg of the core and the primary winding 51 of the flyback transformer may be wound around an upper core 50 of the core and the secondary winding 61 of the flyback transformer may be wound around a lower cote 60 of the core. The boost inductor and the primary winding 51 and the secondary winding 61 of the flyback transformer may have different turns and different winding directions according to a design of a circuit. As such, the boost inductor and the winding of the flyback transformer are integrally wound on the single core to be implemented as a single element, thereby implementing miniaturization of an element, saving manufacturing costs, and facilitating a circuit design.

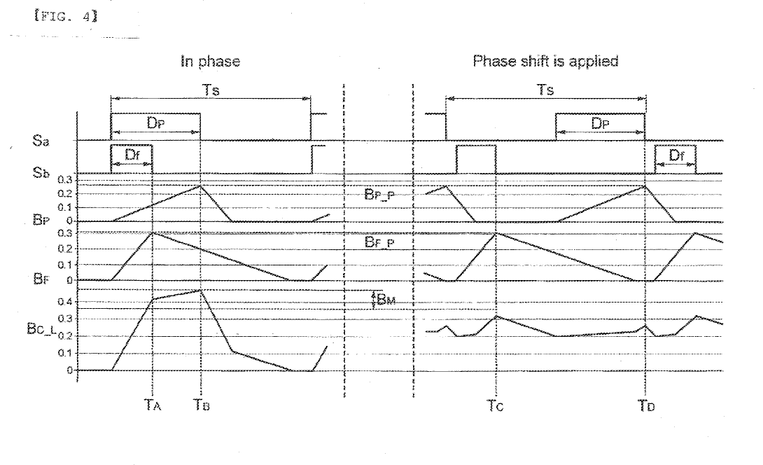

FIG. 3 is a flow diagram of a magnetic flux of the core according to the exemplary embodiment of the present invention.

Referring to FIGS. 2 and 3, a direction of a magnetic flux B_{F} generated from the flyback transformer is indicated by a solid line and a direction of a magnetic flux B_{P} generated from the boost inductor is indicated by a dotted line. Here, it is assumed that the magnetic flux generated from the flyback transformer moves counterclockwise. The magnetic flux generated from the boost inductor equally moves from a central leg of the core to both legs thereof, while the magnetic flux generated from the flyback transformer may move from a right leg to a left leg without passing through the central leg of the core. Therefore, in the right leg of the core, the magnetic flux generated from the flyback transformer is offset with the magnetic flux generated from the boost inductor but in the left leg of the core, the magnetic flux generated from the flyback transformer is summed with the magnetic flux generated from the boost inductor, such that the magnetic density may be different.

FIG. 4 is a graph illustrating a case in which a first switching signal and a second switching signal in an integrated magnetic circuit according to the exemplary embodiment of the present invention are in-phase and a case in which the first switching signal and the second switching signal have a phase shift of 180°.

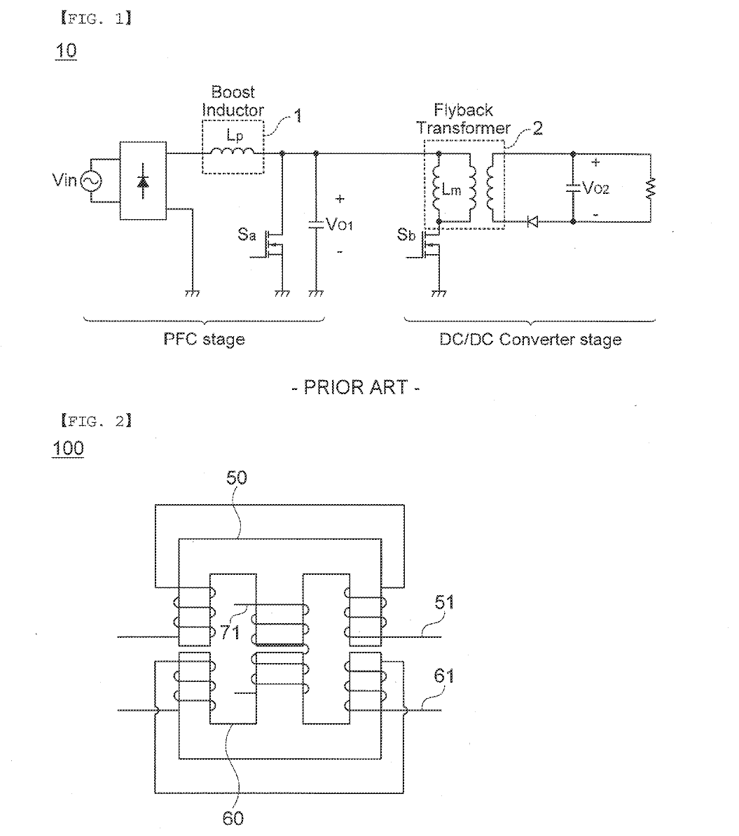

A first switch Sa and a second switch Sb that are shown in FIG. 1 may be applied to the integrated magnetic circuit of FIG. 2. Therefore, the first switch may be connected with the boost inductor and the second switch may be connected with the primary winding 51 of the flyback transformer. That is, the integrated magnetic circuit according to the exemplary embodiment of the present invention may further include a first switch connected with the boost inductor and generating a first switching signal caving a first frequency and a second switch connected with the flyback transformer and generating a second switching signal having a second frequency.

Referring to a left graph of FIG. 4 in which the first switching signal generated from the first switch and the second switching signal generated from the second switch for the core are in-phase, the first switch and the second switch are in-phase and may each be turned-on and turned-off. The graph for a magnetic density B_{P} of the boost inductor according to the turn-on and the turn-off of the first switch is shown and the graph for the magnetic density B_{F} of the flyback transformer according to the turn-on and the turn-off of the second switch is shown. As described above, in the left leg of the core, the magnetic flux of the boost inductor and the magnetic flux or the flyback transformer are summed, which is shown as a graph of the left bottom of FIG. 4. That is, in the left leg of the core, a magnetic density BC_L is shown by summing the magnetic density of the boost inductor and the magnetic density of the flyback transformer and when the summed magnetic density is maximum, exceeds a numerical value of a saturation magnetic density of the core and as a result, there is a problem in that a core cross sectional area of the leg in which the magnetic flux is saturated needs to be increased so as to avoid the magnetic saturation. Therefore, a maximum value of the slimed magnetic density needs not to exceed the numerical value of the saturation magnetic density of the core.

Therefore, according to the exemplary embodiment of the present invention, the first frequency and the second frequency may have a phase shift of 180°. Further, a magnitude in the first frequency and a magnitude in the second frequency may be equal.

Referring to the right graph of FIG. 4 in which the switching signal generated from the first switch and the second switching signal generated from the second switch for the integrated magnetic circuit have a phase shift of 180°, the first switching signal and the second switching signal may each be turned-on and turned-off at a phase shift of 180°. Therefore, the graph of the magnetic density B_{P} of the boost inductor according to the turned-on and the turned-off of the first switch is shown and the graph of the magnetic density B_{F} of the flyback transformer B_{F} according co the turned-on and the turned-off of the second switch is shown and a graph waveform of the magnetic density of each of the B_{P} and the B_{F} is the same as the case in which the first switching signal and the second switching signal are in-phase. In addition, in the graph of the magnetic densities of each of the B_{P} and the B_{F}, the maximum value of the magnetic density is the same as the case in which the first switching signal and the second switching signal are in-phase.

However, the first switch and the second switch have a phase shift of 180° with respect to each other and are each turned-on and turned-off and therefore, the magnetic density that is a sum of the magnetic density of the boost inductor and the magnetic density of the flyback inductor is shown in a graph illustrated in the right bottom of FIG. 4. Therefore, comparing the left and the right of the bottom graph of FIG. 4, there is a problem in that the summed magnetic density exceeds the saturation magnetic density of the core when the first switching signal and the second switching signal are in-phase, but it can be appreciated that the maximum value of the summed magnetic density is reduced when the first switching signal and the second switching signal have a phase shift of 180°. That is, when the first switching signal and the second switching signal have a phase shift of 180°, the maximum magnetic density generated in the left leg of the core is lower than the case in which the first switching signal and the second switching signal are in-phase to prevent the magnetic saturation.

Describing a method of reducing a magnetic density based on the above description, the method of reducing a magnetic density according to the exemplary embodiment of the present invention may include preparing the core including three legs; winding the boost inductor around the central leg of the core; forming the primary winding and the secondary winding of the flyback transformer around the upper leg and the lower leg of the core, respectively; and inputting the first switching signal according to the first frequency to the boost inductor and the second switching signal according to the second frequency having a phase shift of 180° with respect to the first frequency to the primary winding and the secondary winding of the flyback transformer.

The core may be the EE core or the EI core and the first frequency and the second frequency may be the same. A description of the overlapping portion with the above description will be described.

According to the exemplary embodiments of the present invention, it is possible to reduce the volume by the circuit design that winds the boost inductor and the winding of the flyback transformer of the power factor correction stage around the single core and save the manufacturing costs clue to the separate winding thereof.

Further, it is possible to prevent the magnetic flux from being saturated by setting the phase shift between the first switching signal supplied to the boost inductor and the second switching signal supplied to the flyback transformer to be 180°.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An integrated magnetic circuit, comprising:
a power factor correction stage (PFC-stage) including a boost inductor; and
a flyback transformer including a primary winding and a secondary winding,
wherein the boost inductor and the primary winding of the flyback transformer and the secondary winding of the flyback transformer are wound around a single core.

2. The integrated magnetic circuit according to claim 1, wherein the core is an EE core or an EI core,
the boost inductor is wound around a central leg of the core,
the primary winding of the flyback transformer is wound around an upper leg of the core, and
the secondary winding of the flyback transformer is wound around a lower leg of the core.

3. The integrated magnetic circuit according to claim 2, furher comprising:
a first switch connected with the boost inductor and generating a first switching signal having a first frequency; and
a second switch connected with the flyback transformer and generating a second switching signal having a second frequency.

4. The integrated magnetic circuit according to claim 3, wherein the first frequency and the second frequency are the same.

5. The integrated magnetic circuit according to claim 3, wherein the first frequency and the second frequency have a phase shift of 180°.

6. A method of reducing a magnetic density by a phase shift, comprising:
preparing a core including three legs;
winding a boost inductor around a central leg of a core;
forming a primary winding and a secondary winding of a flyback transformer around an upper leg and a lower leg of the core, respectively; and
inputting a first switching signal according to a first frequency to the boost inductor and a second switching signal according to a second frequency having a phase shift of 180° with respect to the first frequency to the primary winding and the secondary winding of the flyback transformer.

7. The method according to claim 6, wherein the core is an EE core or an EI core.

8. The method according to claim 6, wherein the first frequency and the second frequency are the same.
